(19) United States
(12) Patent Application Publication
(10) Pub. No.: US 2024/0095992 A1
(43) Pub. Date: Mar. 21, 2024

(54) GRAPHICS PRIMITIVE ASSEMBLY PIPELINE

(71) Applicant: Arm Limited, Cambridge (GB)

(72) Inventors: Naveen Kumar Singh, Cambridge (GB); Hsiang-Wen Chiu, Lund (SE)

(73) Assignee: Arm Limited, Cambridge (GB)

(21) Appl. No.: 18/468,000

(22) Filed: Sep. 15, 2023

(30) Foreign Application Priority Data
Sep. 20, 2022 (GB) 2213746.7

(51) Int. Cl. G06T 15/00; G06T 1/60

(52) U.S. Cl. CPC G06T 15/005; G06T 1/60

(57) ABSTRACT

There is provided a graphics primitive assembly circuit comprising an early primitive assembly data generator operable to supply primitive input to a shader and a buffer operable to store early primitive assembly data during operation of the shader and to supply the early primitive assembly data to a late primitive assembly circuit element responsive to completion of operation of the shader. The circuit may also include a compressor that compresses the early primitive assembly data to reduce the amount of storage taken up by the buffer and the bandwidth required to transfer the early primitive assembly data.

The present technology relates to graphics processing, and particularly to methods of, and apparatus for, graphics primitive processing and shading in a processing pipeline arrangement.

Graphics processing is normally carried out by first splitting the objects in the scene to be displayed into a number of similar basic components or “primitives”, which primitives are then subjected to the desired graphics processing operations, such as positioning, colouring, texturing and the application of light and shade. The graphics “primitives” are usually in the form of points, lines and simple polygons, such as triangles and/or rectangles.

The primitives for an output, such as a frame to be displayed, are usually generated by the application programming interface for the graphics processing system, using the graphics drawing instructions received from the application that requires the graphics processing. The data defining the attributes of the primitives is typically input in the form of appended or referenced parameter data for the application programming interface commands.

Each primitive is at this stage defined by and represented as a set of vertices. Each vertex for a primitive has associated with it a set of data (such as position, colour, texture and other attributes data) representing the vertex. This “vertex data” is then used, e.g., when rasterising and rendering the primitive(s) to which the vertex relates in order to generate the desired render output of a graphics processing unit (GPU) of a graphics processing apparatus.

For a given output, such as a frame to be displayed, to be generated by graphics processing, a set of vertices are typically defined for the object in question. The primitives to be processed for output are then indicated as comprising given vertices in the set of vertices for the output being generated. Typically, then, the output consist of smaller processing units each having a set of vertices and a set of primitives for these vertices.

Once the primitives and their vertices have been generated and defined, they can be processed in order to generate the graphics processing output, such as a complete frame for display, in a process generally referred to as “rendering.” The rendering process uses the vertex attributes associated with the vertices of the primitives, and to this end, the vertex attributes are processed by what is known as a shader. The vertex shader transforms the attributes for each vertex into an appropriate format for subsequent graphics processing. For example, the vertex position attributes may be transformed from their initial form relative to the original model space in which they are defined into the equivalent positions relative to the display space in which they are to be rendered. The shader may also perform computations for other attributes, such as colour, texture and light and shade.

The graphics processing pipeline thus typically includes a vertex shading stage that performs shading computations on the initial vertex attribute values to generate a suitable set of output vertex values for use in subsequent stages of the pipeline.

Shaders may be implemented either as dedicated circuitry within a graphics processing unit or they may comprise programmed execution units. In any graphics processing unit, there may be several of these execution units or instances of the circuitry, to exploit the benefits of parallel processing. In embodiments, a shader may be implemented as a multi-threading unit that is configured to perform shading actions for multiple vertices at a time.

Once primitives and their vertices have been generated and defined, the primitives can be processed by the graphics processing apparatus, in order, e.g., to display a frame. This processing basically involves determining which sampling points of an array of sampling points covering the output area to be processed are covered by a primitive, and then determining the appearance each sampling point should have (e.g. in terms of its colour, texture etc.) to represent the primitive at that sampling point. These processes are commonly referred to as rasterising and rendering, respectively.

During typical processing of graphics data in a pipeline, there are two parallel pipelines in operation: a primitive assembly pipeline and a shader pipeline. In one arrangement, a prefetcher/early primitive assembler part of the primitive assembly pipeline, after reading an index array, creates primitives along with vertex-IDs, primitive-IDs and instance-IDs. The assembled primitives and their vertex-IDs are allocated inside a vertex cache and vertex-IDs (along with instance-IDs) requiring shading are sent for vertex position shading requests. The use of early primitive assembly has advantages in that it enables the system to analyse the input data and to limit the vertex shading requests to those primitives that require shading actions, while ignoring, for example, vertices that relate to incomplete primitives, and which will therefore not be used in the final output.

Once position shading requests are sent out, the primitive assembly part of the pipeline has to wait for the shader to shade positions and write back the data into position temporary storage. Generally the latency for position shading is quite high in processing cycles. To hide this latency, the primitive assembly part of the pipeline normally has to re-read the index array, re-create and re-allocate the primitives when the position data is returned. Once positions are written into the position temporary storage, the pipeline reads the positions and passes the primitives, along with their positions, to the following stages of graphics processing, such as rasterising and rendering.

The early primitive assembly stage is index-driven based on the input data and produces output based on the primitives in the form of vertex-IDs, primitive-IDs and instance-IDs, along with attribute data. This output data is consumed by the vertex shader which in turn provides shaded position data for the positions in the output image to be rendered. This shaded position data then needs to be applied to the primitive instances in the assembled primitive data as it was produced by the early primitive assembly. The early primitive assembly process thus only partially performs the necessary processing of the primitives, leaving the completion of processing to the late primitive assembly stage, at which point the full information required to complete processing of the primitives and their vertices at their respective positions in the output is available.

Because the primitive assembly pipeline needs to re-read the index array, re-create and re-allocate the primitives for late primitive assembly when the position data is ready, there is an undesirable level of processor resource consumption. Also, the cache containing the index data must be retained throughout the latency period of the shader, and this creates an undesirable memory footprint over time. The re-reading of the index array from the system cache also consumes extra communications bandwidth in the transfer channel.

It would therefore be desirable to reduce this processing and communications bandwidth burden and to keep the memory footprint over time as low as possible, for example by releasing reserved system storage used for caches as quickly as possible and by reducing the amount of data held in storage as much as possible. Now that increasingly sophisticated graphics need to be provided on many small-format devices, it is becoming increasingly important to improve the power consumption efficiency, memory occupancy and communications bandwidth required for graphics processing apparatus and programs.

There are thus provided methods of, and apparatus for, graphics primitive assembly in a pipeline arrangement as defined in the appended claims.

Various embodiments of the technology described herein will now be described, by way of example only and not by way of limitation, with reference to the accompanying drawings, in which:

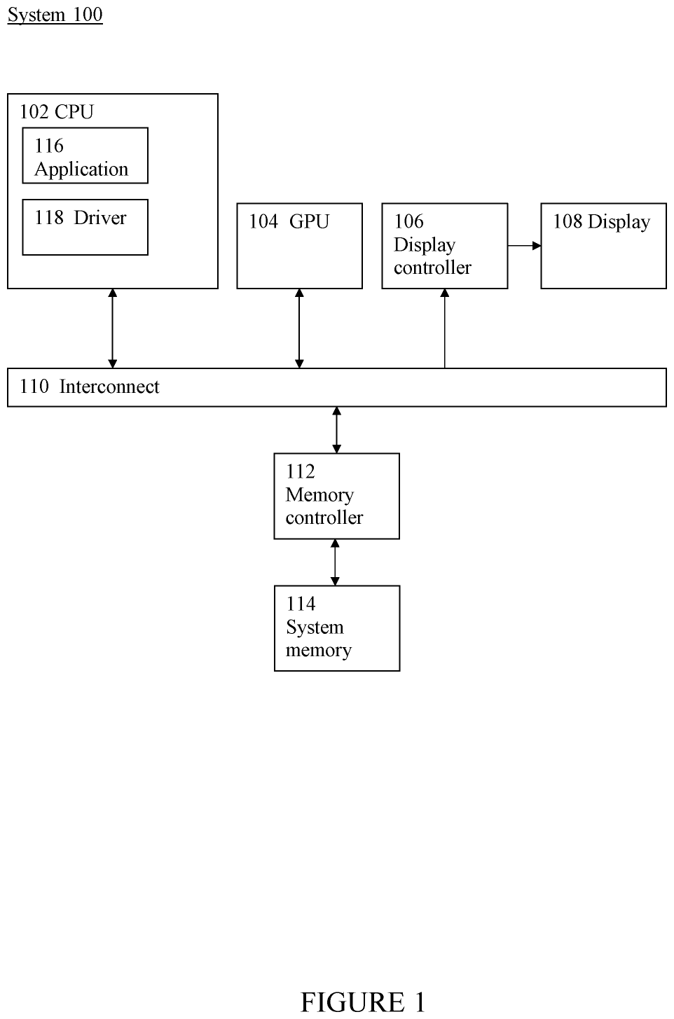

FIG. 1 shows a much-simplified high-level view of an example computing system capable of performing graphics processing;

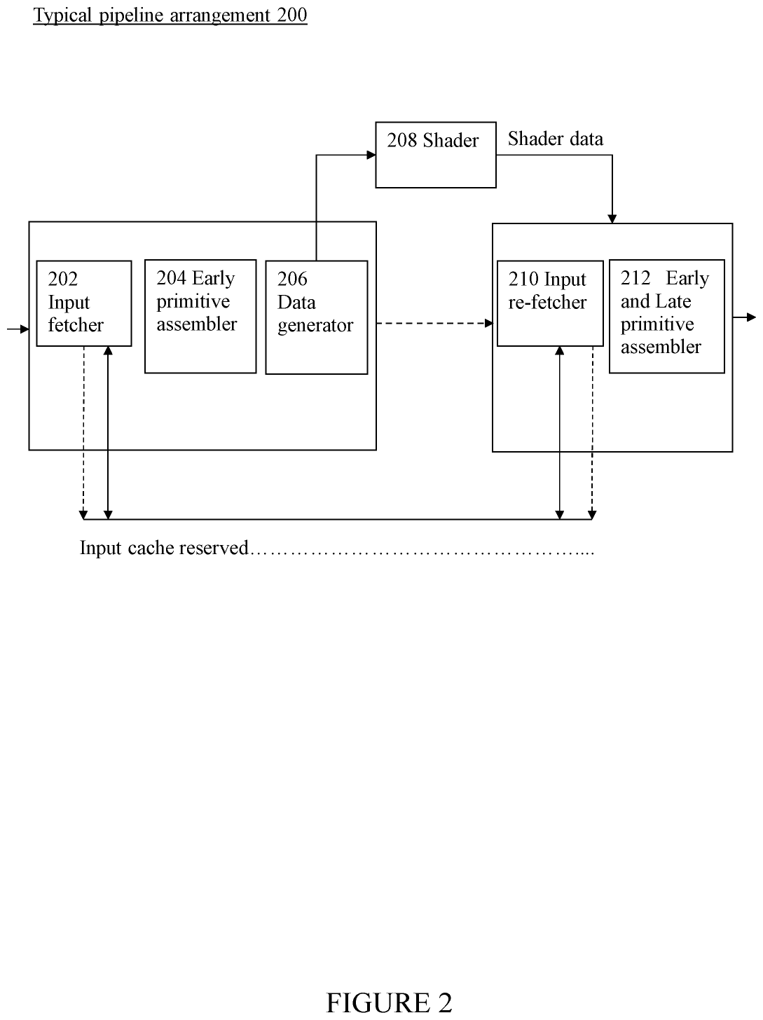

FIG. 2 shows a much-simplified view of an example of a typical arrangement of pipelines involved in primitive assembly;

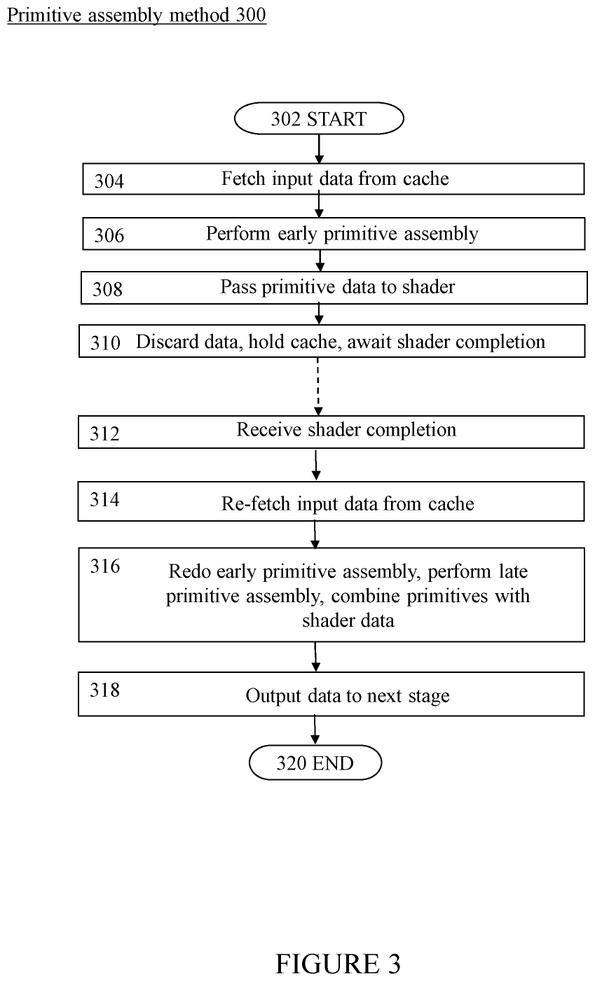

FIG. 3 shows the main elements of a method of operation of a typical primitive assembly pipeline;

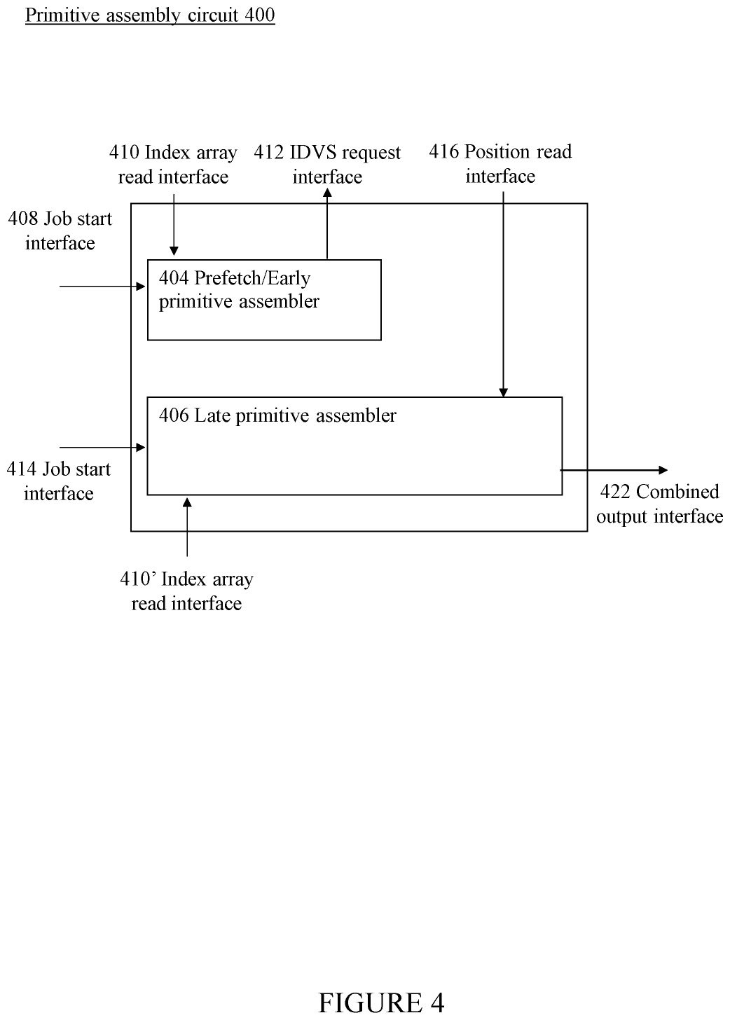

FIG. 4 shows a much-simplified view of a typical primitive assembly circuit and its interfaces;

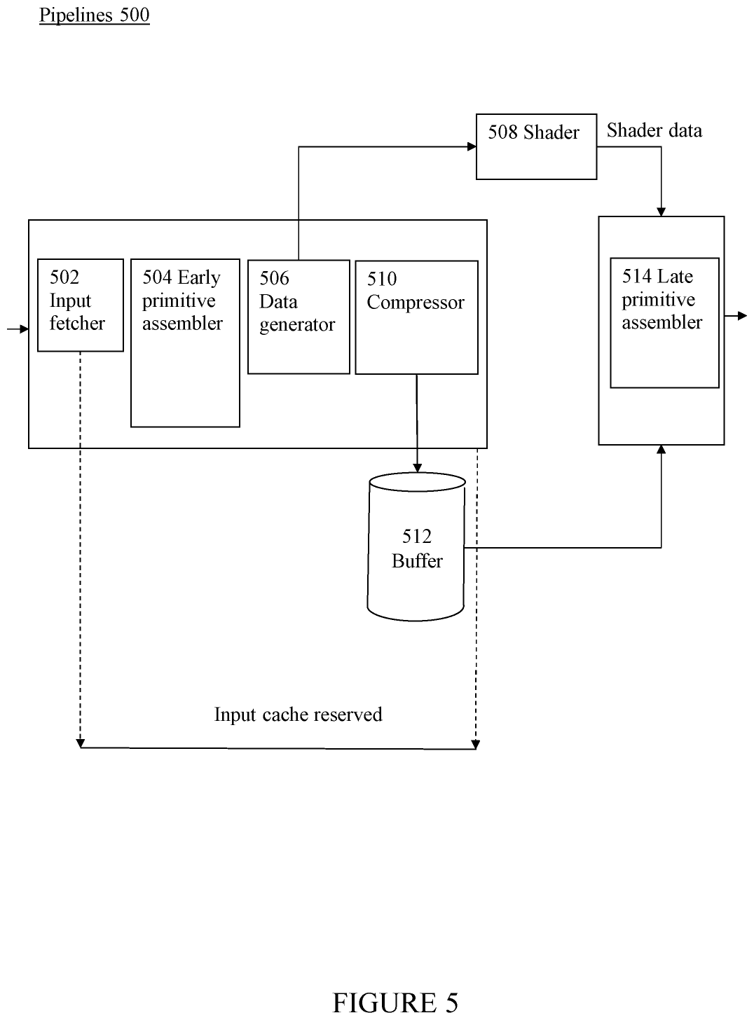

FIG. 5 shows a much-simplified view of an example of an arrangement of pipelines involved in primitive assembly according to an implementation of the present technology; and

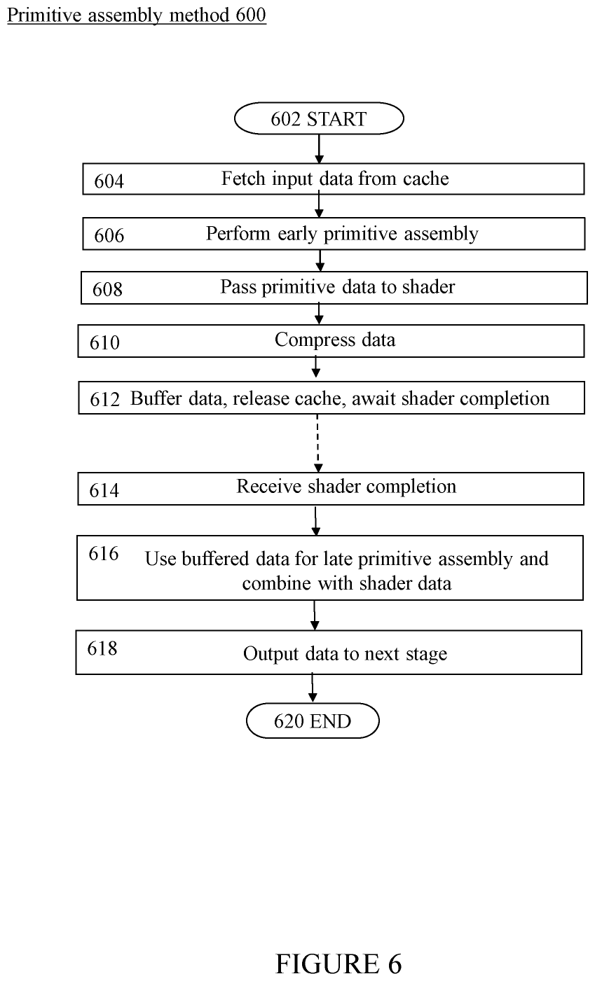

FIG. 6 shows the main elements of a method of operation of a primitive assembly pipeline according to an implementation of the present technology.

A graphics processing apparatus embodying the present technology includes a processing element and a memory. A processing element may include, for example, a central processor unit (CPU), graphics processor unit (GPU), a system-on-chip, an application specific integrated circuit (ASIC), a neural processing unit (NPU), a DSP (digital signal processor), or the like. The processing element may comprise and/or be in communication with a storage system. The memory may include volatile memory (e.g., SRAM, DRAM, etc.) and/or non-volatile memory (e.g., flash memory, non-volatile RAM, etc.). The apparatus may include more than one processor. The apparatus may include more than one memory. The apparatus may comprise graphics output hardware for outputting graphics data to a display, a screen, or a monitor, which may be integral to the apparatus or separate therefrom. The memory may store computer program code which, when executed by the processing element, causes the apparatus to perform a method embodying the present technology.

In an implementation of the present technology, there is provided a graphics primitive assembly circuit comprising an early primitive assembly data generator operable to supply primitive input to a shader and a dedicated buffer separate from the system L2 cache and operable to store the early primitive assembly data during operation of the shader and to supply the early primitive assembly data to a late primitive assembly circuit element responsive to completion of operation of the shader. The term “dedicated” is used here to refer to the buffer being configured, sized and allocated for this single purpose; in this, it differs from the system caches used for temporary storage on behalf of any user program as required. The buffer may be located in storage that is local to the primitive assembly circuit or execution unit. The early primitive assembly circuit or execution unit may also include a compressor that compresses the early primitive assembly data to reduce the amount of storage taken up by the buffer and the interconnect bandwidth required to transfer the early primitive assembly data.

In another implementation of the present technology, there may be supplied a method, such as a computer-implemented method, for operating an electronic circuit to supply primitive input to a shader, to store early primitive assembly data in a buffer during operation of the shader, and to supply the early primitive assembly data to a late primitive assembly circuit element responsive to completion of operation of the shader. The method may be embodied in a computer program product comprising computer program code to, when loaded into a computing system, cause the computing system to operate an electronic circuit to supply primitive input to a shader, to store early primitive assembly data in a buffer during operation of the shader, and to supply the early primitive assembly data to a late primitive assembly circuit element responsive to completion of operation of the shader.

In one implementation, the present technology may comprise a pipelined tiler primitive assembly circuit that is operable to construct tiles of a total image, where the tiler is co-operable with an index-driven vertex shader to supply input to a late primitive assembly circuit element. A tiler is an element of a graphics processing circuit that subdivides an image to be rendered into smaller portions that can be processed more efficiently—each tile can be processed with a small memory footprint, and the bandwidth required for memory transfers of individual tiles is relatively small. In these implementations, an early primitive assembly packet generator is operable to supply primitive input to the index-driven vertex shader and to create early primitive assembly packets for use by the late primitive assembly circuit element. The early primitive assembly packets are stored in, for example, a first-in-first-out temporary store during operation of the index-driven vertex shader and to supply the early primitive assembly packets to said late primitive assembly circuit element when the index-driven vertex shader completes its operations. The use of a first-in-first-out temporary store permits the retention of the original input order between the early primitive assembly stage and the late primitive assembly stage. As will be immediately clear to one of skill in the art, other forms of temporary store and vertex shader may equally well be used and such systems will equally benefit from the application of the present technology.

The primitive assembly circuit of the present technology may be at least partly implemented as a processing element of a GPU. As will be clear to one of ordinary skill in the art, a GPU may be constructed to handle a plurality of pipelines processing graphics data in parallel and interleaved process tasks.

FIG. 1 shows an exemplary hardware system 100 that is capable of graphics processing and comprises a central processing unit (CPU) 102, a graphics processing unit (GPU) 104, a display controller 106, and a memory controller 112. The GPU 104 can implement a graphics processing pipeline such as the ones described hereinbelow.

As shown in FIG. 1, these units communicate via an interconnect 110 and have access to system memory 114 by means of memory controller 112. In this system the GPU 104 generates frames to be displayed and the display controller 106 then provides the frames to a display 108 for display.

In use of this hardware, an application 116, such as a game, executing on the CPU 102 may require the display of frames on the display 108. To do this, the application submits appropriate commands and data to a driver 118 for the graphics processing unit 104. The driver 118 then generates appropriate commands and data to cause the graphics processing unit 104 to render appropriate frames for display and to store those frames in appropriate frame buffers, e.g. in the system memory 114. The display controller 106 then reads those frames into a buffer for the display 108 from where they are then read out and displayed on a display panel of the display 108.

In an arrangement such as that shown in FIG. 1, GPU 104 has a large amount of processing to do and is thus typically arranged in pipelines for parallel and quasi-parallel processing. GPUs such as GPU 104 typically comprise circuitry for handling the complex computations for multiple pipelines, thereby not consuming processing resource of the CPU 102.

A typical pipeline arrangement 200 is shown in FIG. 2. In this arrangement, the portion of graphics processing that comprises the assembly of graphics primitives and the shading of vertices is shown, wherein the processing elements are shown starting at the left and ending on the right. As will be clear to one of skill in the art, the description of the processing performed by the example pipeline has been much simplified for the purposes of illustration of the present technology and its background. The prefetcher/early primitive assembly stage of the pipeline begins with an input fetcher 202 operable to fetch input comprising index data from a system cache for consumption by early primitive assembler 204. The system cache remains reserved for later reuse of the input data. This is because, in this arrangement, the early primitive assembly stage is only capable of performing a part of the overall task of preparing the primitives for use by subsequent stages of the processing of the image, and thus the original input data is needed again after the shader has completed its operations. Early primitive assembler 204 is operable to provide data to a data generator 206 which is operable to pass vertex data to shader 208. Shader 208 is operable to calculate vertex data and then to re-awaken the primitive assembly pipeline when shading is complete and provide the pipeline with the calculated shader data. Shader 208 may be implemented in circuitry, which may be incorporated into a graphics processing unit, or it may take the form of a programmed execution unit operable within programmable multi-purpose circuitry. Input re-fetcher 210 is operable to fetch the input comprising index data from the system cache. After the operation of the re-fetcher 210 the system cache may be released, or it may be released at completion of the whole late primitive assembly stage of the process. The early and late primitive assembler 212 is operable to consume and process the input data through both the early and late parts of primitive assembly, and the combined assembled primitive data and shader data are output to computing entities (not shown) responsible for the next graphics processing stage.

The operation of the pipeline of FIG. 2 implements a primitive assembly method 300 as shown in FIG. 3. The process is initiated at START 302 and at 304, the pre-fetcher described above acquires access to a cache and fetches the input, for example including index data, from the cache. The cache is provided by the system 100 of FIG. 1—typically the cache is provided in the system memory shown at 114 of FIG. 1. In a typical implementation, this is system L2 cache. Access to such caches is made exclusive for the period that the cache is reserved by a processing entity, such as the presently-described graphics primitive assembly pipeline. At 306, the pipeline performs early primitive assembly to extract and arrange the image data in appropriate formats for further processing. The requisite primitive data is then passed to the shader at 308, and at 310, in order to hide the lengthy delay, or latency, caused by the computational complexity of shader operations, the primitive assembly pipeline enters a wait state. Hiding the shader latency, in effect, means releasing the intervening processing cycles of the primitive assembly pipeline for other uses by the system. To achieve this, the assembled early primitive assembly data is discarded when the pipeline enters the wait state, and the cache is retained in reserved state for re-use later, when the shader computations have completed.

When the shader computations are completed, at 312, this fact is signalled to the primitive assembly pipeline, which restarts its processing by re-fetching 314 the input data from the cache. At 316, the primitives are assembled by re-doing early primitive assembly and performing late primitive assembly and combined with the shader data, ready for output at 318 to the next stage in graphics processing. The pipeline completes its processing at END 320. As will be clear to one of ordinary skill in the art, END 320 may be followed by further iterations of the pipeline process 302-320 as required.

In this typical arrangement, the assembly of the primitives is in two parts—early and late assembly. The early assembly process comprises those assembly actions that can be performed before the vertex shading characteristics are known. The late assembly process comprises those actions that can be completed once the vertex shading characteristics are known. In this arrangement, the early assembly process is performed twice—once to provide input to the shader and again to provide input to the late assembly process. Both these processes are necessarily driven by the same input index data, as in this arrangement the early primitive assembly data comprising partially assembled primitives is used to generate and supply input to the shader.

A simplified view of a typical primitive assembly circuit 400 and its interfaces is shown in FIG. 4. Prefetch/early primitive assembler 404 is activated by a job start interface 408 and reads input data through index array read interface 410. Prefetch/early primitive assembler 404 is operable to perform primitive assembly and to output index-driven vertex shader requests through interface 412 to pass data to a vertex shader as described hereinabove.

Typically, the operation of prefetch/early primitive assembler 404 completes operation after it has passed this data to the shader. Late primitive assembler 406 is operable when initiated by job start interface 414, typically when signalled that the shader operations on the data sent over index-driven vertex shader request interface 412 have been completely processed. Late primitive assembler 406 reads input data through index array read interface 410′. This repeats the read previously performed by prefetch/early primitive assembler 404. Late primitive assembler 406 reads a position parameter at 416 position read interface. Late primitive assembler 406 is operable to construct a combined output comprising the shaded vertex data and positioning data relative to the image space and to pass this out at 422 combined output interface, ready for the next stage of processing.

Turning now to FIG. 5, there is shown a simplified view of an example of an arrangement of pipelines involved in primitive assembly according to an implementation of the present technology. As will be clear to one of skill in the art, the description of the processing performed by the example pipeline has been much simplified for the purposes of illustration of the present technology and its background. In this arrangement, the portion of graphics processing that comprises the assembly of graphics primitives and the shading of vertices is shown, wherein the processing elements are shown starting at the left and ending on the right. Input fetcher 502 is operable to fetch input comprising index data from a system cache for consumption by early primitive assembler 504. Early primitive assembler 504 is operable to provide data to a data generator 506 which is operable to pass vertex data to shader 508. Shader 508 is operable to calculate vertex data and then to provide the primitive assembly pipeline with the calculated shader data. Shader 508 may be an index-driven vertex shader. Data generator 506 is further operable to provide assembled early primitive assembly data to compressor 510. Compressor 510 is operable to compress the primitive data, for example by using a substitution table for identifiers, by reducing data of culled primitives to a one-bit absence indicator, or by substituting base-and-offset position indicators for full vertex position indicators. Compressor 510 is operable to pass the compressed data to buffer 512, which may be located in a local memory of the primitive assembly circuit. Buffer 512 comprises dedicated storage separate from the system cache, and thus can be tailored to a size that is adequate for the compressed early primitive assembly data, but need not be larger—it may therefore have a smaller storage footprint than a system cache, which is by nature constructed to handle the general cases of temporary storage requirements of the system. The buffer may also be located in local storage, thus reducing the consumption of interconnect bandwidth over, for example, a main system bus. Buffer 512 provides temporary storage for the compressed early assembled primitive data, and may be implemented as a first-in-first-out buffer to preserve the processing order as received at the input stage by input fetcher 502. Because the early assembled primitive data is preserved in compressed form in buffer 512, there is now no requirement for the input cache to remain reserved during operation of shader 508 or for supply of data to any subsequent stage of processing. This means that the input cache (typically a system L2 cache) may be made available for other purposes as soon as its content has been consumed by the early primitive assembly stage. As will be clear to one of ordinary skill in the art, this does not mean that the cached data must be evicted—the present technology may leave the cached data intact for use by another process or thread. When shader 508 completes its processing, late primitive assembler 514 is operable to receive and process the shader data from shader 508 and the early assembled primitive data from buffer 512. Late primitive assembler 514 is further operable to output the combined early and late assembled primitive data and shader data to computing entities (not shown) responsible for the next graphics processing stage. As can be seen, there is now no requirement for an input re-fetcher of the type shown at 212 of FIG. 2, as the early assembled primitive data is supplied from buffer 512. There is also no need to redo the early primitive assembly process, as the early assembled primitive data has been retained in compressed form in the buffer 512.

Turning to FIG. 6, there is shown a method 600 of operation of a primitive assembly pipeline according to an implementation of the present technology. The process begins at START 602 and at 604, input data is fetched from the cache. At 608 early primitive assembly is performed using the input data to produce the early assembled primitive data. At 608, the early assembled primitive data is passed in appropriate form to the shader. At 610, the early assembled primitive data is compressed. The early assembled primitive data may be compressed by using a substitution table for identifiers, whereby a shorter vertex identifier may be substituted for the full-length vertex identifier. In one implementation, a small set (for example 256) of replacement vertex identifiers may be used as a dictionary to re-encode the identifiers—in most instances, this number will not be exceeded. In addition, data relating to culled primitives may be compressed to a one-bit absence indicator. Also, by substituting base-and-offset position indicators for full vertex position indicators, the vertex data may be compressed. It will be clear to one of ordinary skill in the art that any other form of compression may equally well be applied in addition to the above described exemplary measures. After compression at 610, at 612 the early assembled primitive data is sent to the buffer described hereinabove, which may be a first-in-first-out buffer to preserve the processing sequence according to the fetch sequence of input data. The input cache may now be released, as the data required for later processing has been preserved in the buffer. At 612, the primitive assembly pipeline then enters a wait state pending completion of operation of the shader. At 614, the shader completes processing the shading attributes for the vertices of the early primitives that were derived from the input data fetched at 604. The primitive assembly pipeline re-awakens from its wait state at 614 to read and parse the early assembled primitive data from the buffer where it was stored during the wait for shader operation. The parsing may include decompression of the compressed form of data, and the early assembled primitive data is then at 616 used for late primitive assembly and combined with the data from the shader to produce output data suitable for use by the next stage in the graphics processing. At 618, the combined early/late assembled primitive and shader data is output to the next stage of graphics processing. The method 600 completes at END 620. As will be clear to one of ordinary skill in the art END 620 may be followed by further iterations of the pipeline process 602-620 as required.

In the manner described hereinabove, the present technology addresses some shortcomings of the graphics processing art by providing a graphics primitive assembly circuit that has an early primitive assembly data generator to supply primitive input to a shader and a dedicated buffer, which may be in local storage, for storing the early primitive assembly data while waiting during the latency of the shader, so that the original input data does not need to be re-fetched from the input cache and re-processed. The use of a local buffer in this context may advantageously also limit the system-level interconnect bandwidth (such as system bus bandwidth) consumption of the primitive assembly and shading process. The circuit supplies the early primitive assembly data to a second stage primitive assembly circuit element when the shader finishes processing. The circuit may also include a compressor that compresses the early primitive assembly data to reduce the amount of storage taken up by the buffer and the interconnect bandwidth required to transfer the early primitive assembly data.

In this arrangement, the assembly of the primitives is still in two parts—early and late assembly. The early assembly process comprises those assembly actions that can be performed before the vertex shading characteristics are known. The late assembly process comprises those actions that can be completed once the vertex shading characteristics are known. In the present arrangement, the early assembly process is performed only once—the data is used to provide input to the shader and is then buffered to provide input to the late assembly process without the need to redo the early assembly process.

The primitive assembly circuit may form part of a tiler element of a graphics processor. However, it will be clear to one of skill in the art that the present technology is not limited to tiled graphics processing implementations.

The buffer that is used to retain the early primitive assembly data during the wait for the shader to complete processing may comprise a dedicated buffer—that is, a buffer that is allocated solely for this purpose, and thus may be configured and sized purely according to the requirements of the task in hand. In this, it advantageously differs from the use of general purpose system caches, such as system L2 cache, which are configured and sized to meet the general case needs of any system user program, and cannot be tailored specifically to the needs of any one task. A dedicated buffer further advantageously avoids the need for any form of contention control, yet further reducing the resource requirements of the present technology.

The buffer may be implemented in a random access memory located locally to the primitive assembly circuit, and may comprise a first-in-first-out buffer to preserve a sequence of the data. The input data may comprise an index of vertices, and the shader may be an index-driven vertex shader.

The compressor may use reduced representations of identifiers, for example, by creating and using a substitution dictionary of reduced representations; the dictionary may comprise reusable elements and may have a temporal depth that allows for the expected number of substitutions that may be required. The compressor may reduce the lengths of the representations of vertex positions by implementing a base and offset arrangement. The compressor may further use a presence/absence bitmap to reduce the lengths of representations of culled primitives, for example, to a single-bit absence indicator.

As will be appreciated by one skilled in the art, the present technology may be embodied as a method, a circuit, a computer program product, an apparatus, or a system. Accordingly, the present techniques may take the form of an entirely hardware embodiment, an entirely software embodiment, or an embodiment combining software and hardware.

For example, an application may provide shader programs to be executed using a high-level shader programming language, such as OpenGL® Shading Language (GLSL), High-level Shading Language (HLSL), Open Computing Language (OpenCL), etc. These shader programs may then be translated by a shader language compiler to binary code for a target graphics processing pipeline. This may include creating one or more internal, intermediate representations of the program within the compiler. The compiler may, for example, be part of a driver, with there being a special API call to cause the compiler to run. The compiler execution can thus be seen as being part of the draw call preparation done by the driver in response to API calls generated by the application.

Furthermore, the present techniques may take the form of a computer program product embodied in a computer readable medium having computer readable program code embodied thereon. The computer readable medium may be a computer readable signal medium or a computer readable storage medium. The computer readable storage medium may be a non-transitory computer readable storage medium encoded with instructions that, when performed by a processing means, cause performance of the method described above. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object, or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™, SystemVerilog, or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods, or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, the preferred embodiment of the present techniques may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present techniques.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

1. A primitive assembly circuit, comprising:
an early primitive assembly data generator operable to supply primitive input to a shader; and
a buffer operable to store early primitive assembly data during operation of the shader and to supply the early primitive assembly data to a late primitive assembly circuit element responsive to completion of operation of the shader.

2. The primitive assembly circuit according to claim 1, the early primitive assembly data generator further operating a compressor to compress the early primitive assembly data before storage in the buffer.

3. The primitive assembly circuit according to claim 2, the compressor comprising a presence/absence bitmap to reduce data of culled primitives to a one-bit absence indicator.

4. The primitive assembly circuit according to claim 2, the compressor operable to use a base-and-offset position indicator for a primitive vertex.

5. The primitive assembly circuit according to claim 1, the compressor comprising a substitution table operable to substitute a reduced length identifier for a vertex identifier.

6. The primitive assembly circuit according to claim 1, the early primitive assembly data generator further operable to release an input cache responsive to completion of storing the early primitive assembly data in the buffer.

7. The primitive assembly circuit according to claim 1, the buffer being located in a local memory of the primitive assembly circuit.

8. The primitive assembly circuit according to claim 1, the shader being an index-driven vertex shader.

9. The primitive assembly circuit according to claim 1, comprising a tiler for partitioning image data into tiles for processing.

10. A method of operating a primitive assembly circuit comprising:
supplying early primitive assembly data to a shader;
storing the early primitive assembly data in a buffer during operation of the shader; and
supplying the early primitive assembly data from the buffer to a late primitive assembly circuit element responsive to completion of operation of the shader.

11. The method according to claim 10, further comprising operating a compressor to compress the early primitive assembly data before storing in the buffer.

12. The method according to 11, operating the compressor comprising using a presence/absence bitmap to reduce data of culled primitives to a one-bit absence indicator.

13. The method according to claim 11, operating the compressor comprising using a base-and-offset position indicator for a primitive vertex.

14. The method according to claim 11, operating the compressor comprising using a substitution table to substitute a reduced length identifier for a vertex identifier.

15. The method according to claim 10, releasing an input cache responsive to completion of storing the early primitive assembly data in the buffer.

16. The method according to claim 10, storing the early primitive assembly data in a buffer comprising storing data in a buffer located in a local memory of the primitive assembly circuit.

17. A computer program comprising computer program code to, when loaded into a computer system and executed thereon, perform the method according to claim 10.
